(19) United States
(12) Patent Application Publication
(10) Pub. No.: US 2007/0286431 A1
(43) Pub. Date: Dec. 13, 2007

(54) Headset

(75) Inventor: Hsien-Cheng Chou, Taipei (TW)

Correspondence Address: BIRCH STEWART KOLASCH & BIRCH, PO BOX 747, FALLS CHURCH, VA, 22040-0747, US

(73) Assignee: Microlink Communications Inc.

(21) Appl. No.: 11/439,998

(22) Filed: May 25, 2006

(51) Int. Cl. H04R 1/10

(52) U.S. Cl. 381/74

(57) ABSTRACT

A headset includes a pair of earpieces containing wide range speakers capable of outputting wide range sound, a printed circuit board and a connecting device connecting to the earpieces. The printed circuit board includes a receiver for receiving audio signal and transmitting the audio signal to a mixed circuit and a low pass filter. The low pass filter divides a low frequency audio signal from the audio signal and transmits the low frequency audio signal back to the mixed circuit. The mixed circuit adds the audio signal and the low frequency audio signal to from an enhanced low frequency signal and then transmits the enhanced low frequency signal to an amplifier. The amplifier amplifies the enhanced low frequency signal and transmits an amplified signal having enhanced low frequency effect to the wide range speakers. The wide range speakers transform the amplified signal to sound having bass effect.

### BACKGROUND OF THE INVENTION

1. Field of the Invention

The invention relates to a headset, and particularly to a headset capable of enhancing and outputting bass sound.

2. The Related Art

With rapid development of electrical technology, portable electrical products capable of playing digital music, such as compact disc players, personal digital accesses and mobile phones etc, are generally used. A headset is one kind of electrical devices capable of applying to the electrical products and outputting sound.

FIG. 9 and FIG. 10 show a conventional headset 900 having a pair of earphones 90, 91, a connecting device 92 connected with the earphones 90, 91. The earphones 90, 91 respectively have speakers 93, 94 for outputting sound. A printed circuit board (not shown in the figures) is arranged at one of the earphones 90, 91, which includes a receiver 95 for receiving audio signal and transmitting the audio signal to an amplifier 96. The amplifier 96 amplifies the audio signal and transmits an amplified audio signal to the speakers 93, 94. The speakers 93, 94 transform the amplified audio signal to normal sound and output the normal sound. However, the headset 900 neither enhances a special audio range nor outputs the special range sound since users only listen to the normal sound and the headset 900 only outputs the normal sound.

### SUMMARY OF THE INVENTION

An object of the present invention is to provide a headset capable of enhancing and outputting sound with bass effect.

According to the invention, the headset includes a pair of earphones respectively containing a wide range speaker capable of outputting wide range sound, and a printed circuit board. A connecting device respectively connects to the earphones. The printed circuit board includes a receiver for receiving audio signal and respectively transmitting the audio signal to a nixed circuit and a low pass filter. The low pass filter transforms the audio signal to a low frequency audio signal and transmits the low frequency audio signal to the mixed circuit. The audio signal and the low frequency audio signal are added to from an enhanced low frequency signal via the mixed circuit. The mixed circuit transmits the enhanced low frequency signal to an amplifier. The amplifier amplifies the enhanced low frequency signal and transmits an amplified signal with enhanced low frequency effect to the wide range speaker. The wide range speaker transforms the amplified signal to sound with bass effect and outputs the sound.

Another object of the present invention is to provide a headset which includes an adjuster unit connecting to the amplifier. According to various indication signals transmitted from the adjuster unit, the amplifier capable of outputting the amplified signal with selected enhanced low frequency effect.

A further object of the present invention is to provide a headset which includes a processor unit respectively connected to the amplifier and the wide range speaker. In case the amplifier outputs the amplified signal with distortion signal to the processor unit, the processor unit divides the distortion signal from the amplified signal and only transmits the amplified signal to the wide range speaker for ensuring that the wide range speaker receives useful amplified signal.

That is users can listen sound with bass effect according to the mixed circuit transforms the audio signal to the enhanced low frequency signal, the amplifier outputs the amplified signal with selected enhanced low frequency effect by receiving the indention signal from the adjuster unit, the processor unit divides the distortion signal from the amplified signal and the wide speaker transforms the amplified signal to sound with bass effect and outputs the sound.

### BRIEF DESCRIPTION OF THE DRAWINGS

The present invention will be apparent to those skilled in the art by reading the following description of a preferred embodiment thereof, with reference to the attached drawings, in which:

FIG. 1 shows a headset according to the present invention;

FIG. 2 is a function block diagram showing a first preferred embodiment of the headset;

FIG. 3 shows another headset having an adjuster unit;

FIG. 4 is a function block diagram showing the second preferred embodiment of the headset;

FIG. 5 shows a third preferred embodiment of the headset;

FIG. 6 is a function block diagram showing the third preferred embodiment of the headset;

FIG. 7 shows a fourth preferred embodiment of the headset with two adjuster units;

FIG. 8 is a function block diagram showing the forth preferred embodiment of the headset;

FIG. 9 shows a conventional headset; and

FIG. 10 is a function block diagram of the conventional headset.

### DETAILED DESCRIPTION OF THE PREFERRED EMBODIMENT

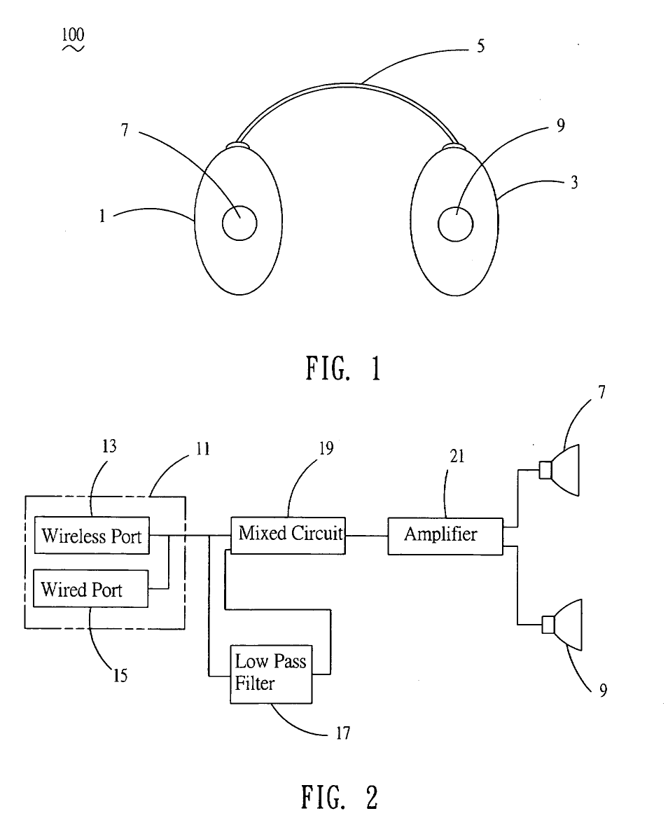

Firstly referring to FIG. 1, a first preferred embodiment of a headset 100 according to the present invention includes a pair of earphones 1, 3. A connecting device 5 is connected with the earphones 1, 3. The earphones respectively contain wide range speakers 7, 9 capable of outputting wide range sound. A printed circuit board (not shown in the figures) is arranged in one of the earphones 1, 3 and is electronically coupled with the wide range speakers 7, 9. In case the printed circuit board is arranged in the earphone 1, the wide range speaker 9 is electronically coupled with the printed circuit through the connecting device 5. In case the printed circuit board is arranged in the earphone 3, the wide range speaker 7 is electronically coupled with the printed circuit via the connecting device 5.

Referring to FIG. 2, the printed circuit board includes a receiver 11 for receiving audio signal from electrical products, for example, personal digital accesses, mobile phones, etc. The receiver 11 has a wireless port 13 and a wired port 15. If the audio signal is transmitted via wireless interface, for example, bluetooth interface, the wireless port 13 will receive the audio signal and the wired port 15 will be inactive. If the audio signal is transmitted via wired interface, for example, a cable, the wired port 15 will input the audio signal and the wireless port 13 will be inactive. The receiver 11 transmits the audio signal to a low pass filter 17 and a mixed circuit 19 as well.

Still referring to FIG. 2, particularly, the low pass filter 17 divides a low frequency audio signal from the audio signal and then transmits the low frequency audio signal back to the mixed circuit 19. Once the mixed circuit 19 receives the audio signal from the receiver 11 and the low frequency audio signal, the mixed circuit 19 adds the audio signal and the low frequency signal to generate an enhanced low frequency signal, and then transmits the enhanced low frequency signal to an amplifier 21. The amplifier 21 amplifies the enhanced low frequency signal and then transmits an amplified signal having enhanced low frequency effect to the wide range speakers 7, 9. The wide range speakers 7, 9 transform the amplified signal to sound having bass effect and output the sound.

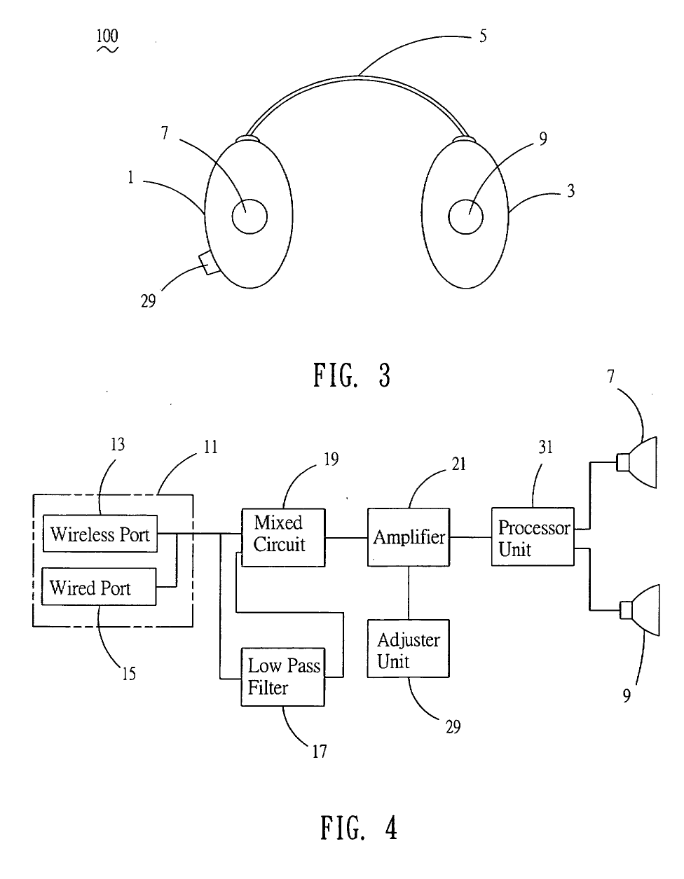

Please refer to FIG. 3 and FIG. 4. A second preferred embodiment of the invention wherein the headset 100 further includes an adjuster unit 29 disposed on the printed circuit board and electronically coupled with the amplifier 21. According to selective signals received by the adjuster unit 29, the adjuster unit 29 transmits selective indention signals to the amplifier 21. Therefore, the amplifier 21 capable of outputting the amplified signal having selective enhanced low frequency effect according to the selective indication signals transmitted from the adjuster unit 29.

Still referring to FIG. 3 and FIG. 4, a processor unit 31 is connected to the amplifier 21 and the wide range speakers 7, 9. The process unit 31 receives the amplified signal from the amplifier 21. In case the amplifier 21 outputs the amplified signal with distortion signal to the processor unit 31, the processor unit 31 divides the distortion signal from the amplified signal for ensuring that the wide range speakers 7, 9 only receives amplified signal.

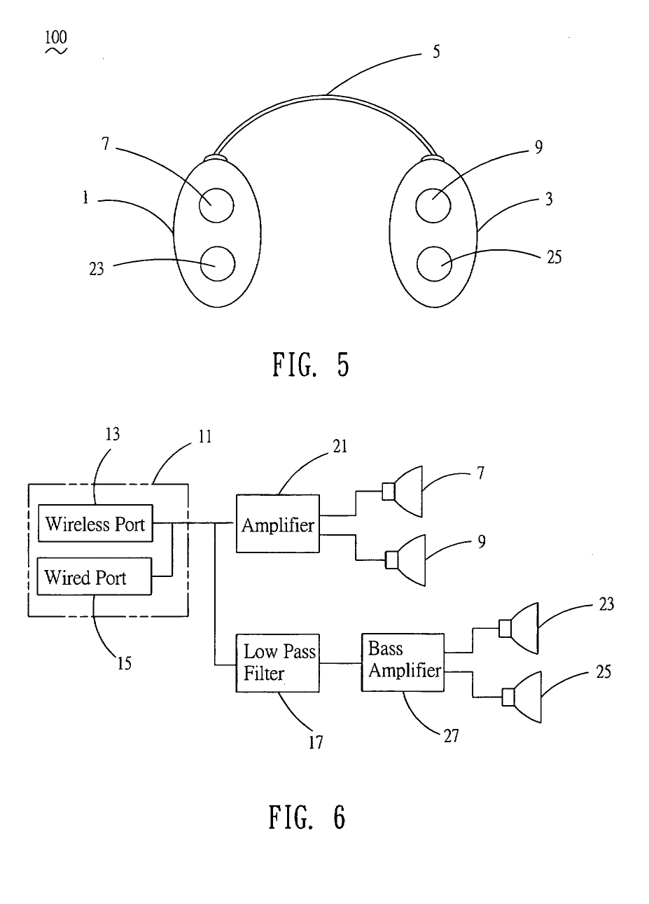

As showing in FIG. 5, a third preferred embodiment of the headset 100 according to the present invention includes the earphones 1, 3. The connecting device 5 is bridging between the earphones 1, 3. The earphones respectively contain the wide range speakers 7, 9 capable of outputting wide range sound, and bass speakers 23, 25 capable of outputting bass sound. The printed circuit board is arranged in one of the earphones 1, 3 and connected to the wide range speakers 7, 9 and the bass speakers 23, 25. In case the printed circuit board is arranged in the earphone 1, the wide range speaker 9 and the bass speaker 25 are connected to the printed circuit through the connecting device 5. In case the printed circuit board is arranged in the earphone 3, the wide range speaker 7 and the bass speaker 23 are connected to the printed circuit via the connecting device 5.

Referring to FIG. 6, the printed circuit board includes the receiver 11 for receiving the audio signal from the electrical products. The receiver 11 has the wireless port 13 and the wired port 15. If the audio signal is transmitted via wireless interface, the wireless port 13 receives the audio signal and the wired port 15 is therefore inactive. If the audio signal is transmitted via wired interface, the wired port 15 receives the audio signal and the wireless port 13 is therefore inactive. The receiver 11 respectively transmits the audio signal to the low pass filter 17 and the amplifier 21.

Still referring to FIG. 6, the amplifier 21 amplifies the audio signal and respectively transmits a normal amplified signal to the wide range speakers 7, 9. The wide range speakers 7, 9 transform the normal amplified signal to normal sound and output the normal sound. The low pass filter 17 divides the low frequency audio signal from the audio signal and then transmits the low frequency audio signal to a bass amplifier 27. The bass amplifier 27 amplifies the low frequency audio signal and then transmits an amplified low frequency signal to the bass speakers 23, 25. The bass speakers 23, 25 transform the amplified low frequency signal to sound with bass effect and output the sound.

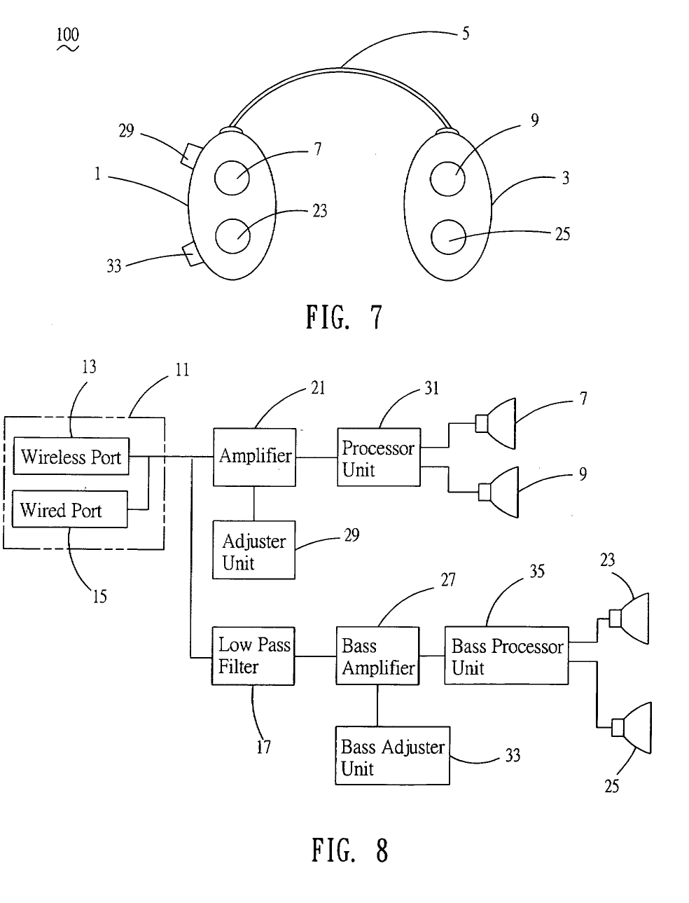

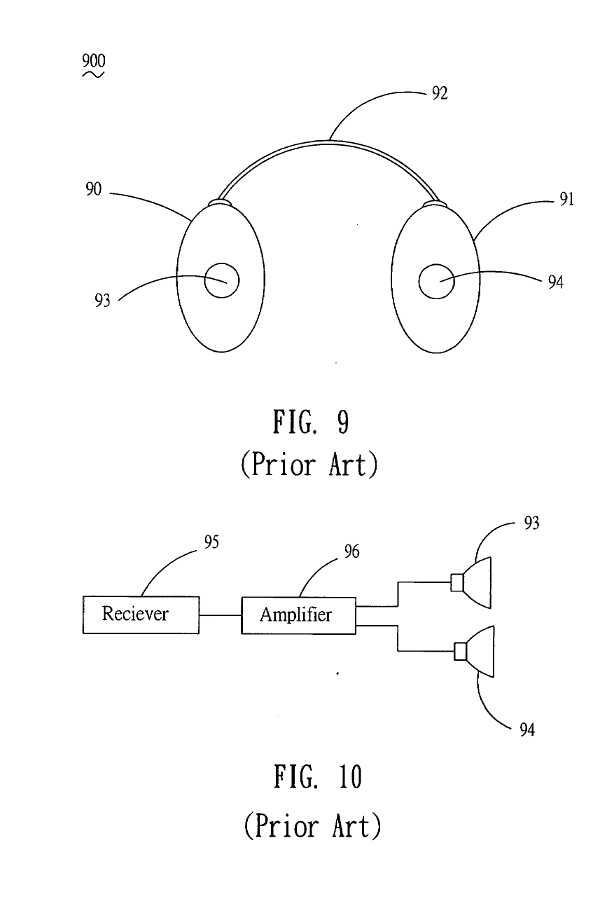

Please refer to FIG. 7 and FIG. 8. A fourth preferred embodiment of the invention wherein the headset 100 includes the adjuster unit 29 disposed on the printed circuit board and connected to the amplifier 21. The adjuster unit 29 transmits selective indention signals to the amplifier 21. Therefore, the amplifier 21 capable of outputting the normal amplified signal having selective amplified effect according to the various indication signals transmitted from the adjuster unit 29. The processor unit 31 is connected to the amplifier 21 and the wide range speakers 7, 9, and receives the normal amplified signal from the amplifier 21. In case the amplifier 21 outputs the normal amplified signal with distortion signal to the processor unit 31, the processor unit 31 divides the distortion signal from the normal amplified signal for ensuring that the wide range speakers 7, 9 only receives normal amplified signal.

Still referring to FIG. 8, a bass adjuster unit 33 is disposed on the printed circuit board and connected to the bass amplifier 27. The adjuster unit 33 transmits selective indention signals to the bass amplifier 27. Therefore, the bass amplifier 27 capable of outputting the amplified low frequency signal having selective amplified effect according to the selective indication signals transmitted from the bass adjuster unit 33. A bass processor unit 35 is respectively connected to the bass amplifier 27 and the bass speakers 23, 25, and is received the amplified low frequency signal from the amplifier 21. In case the bass amplifier 27 outputs the amplified low frequency signal with distortion signal to the bass processor unit 35, the bass processor unit 35 divides the distortion signal from the amplified low frequency signal and only transmits the amplified low frequency signal to the bass speakers 23, 25 for ensuring that the bass speakers 23, 25 only receives amplified low frequency signal.

Users can listen to a sound with bass effect in conjunction with the setup of the mixed circuit and the low pass filter for transforming the audio signal to the enhanced low frequency signal, further by receiving the indention signal from the adjuster unit 29. The processor unit 31 divides the distortion signal from the amplified signal The adjuster unit 33 transmits selective indention signals to the bass amplifier 27 for ordering that the bass amplifier 27 outputs the amplified low frequency signal with selective amplified effect, the bass processor unit 35 divides the distortion signal from the amplified low frequency signal and the bass speaker 23, 25 transform the amplified low frequency signal to sound with bass effect and output the sound.

The foregoing description of various implementations has been presented for the purposes of illustration and description. It is not intended to be exhaustive or to limit the scope to the precise form disclosed. Many modifications and variations are possible in light of the above teaching. Such modifications and variations are intended to be included within the scope of this invention as defined by the accompanying claims.

What is claimed is:

1. A headset comprising:
a pair of earphones;
a connecting device connected with said earphones;
a pair of wide range speakers contained in said earphones; and
a printed circuit board electronically coupled with said wide range speakers and said printed circuit board comprising
a receiver for receiving audio signal, a low pass filter receiving said audio signal and dividing low frequency audio signal from said audio signal and then outputting said low frequency audio signal,
a mixed circuit receiving said audio signal and adding said low frequency audio signal to said audio signal to form an enhanced low frequency signal,
an amplifier receiving said enhanced low frequency signal and transmitting an amplified signal having enhanced low frequency effect to said wide range speakers, said wide range speakers transforming said amplified signal to sound having bass effect.

2. The headset as claimed in claim 1, wherein said receiver comprises a wireless port for receiving said audio signal via wireless interface and a wired port for receiving said audio signal via wired interface.

3. The headset as claimed in claim 1, further comprising an adjuster unit electronically coupled with said amplifier, said amplifier outputting said amplified signal having selective enhanced low frequency effect according to selective indication signals transmitted from said adjuster unit.

4. The headset as claimed in claim 1, further comprising a processor unit electronically coupled with said amplifier and said wide range speakers respectively, in case said amplifier outputting said amplified signal with distortion signal to said processor unit, said processor unit dividing said distortion signal from said amplified signal.

5. A headset comprising:
a pair of earphones;
a connecting device connected with said earphones;
a pair of wide range speakers and a pair of bass speakers contained in said earphones; and
a printed circuit board electronically coupled with said wide range speakers and said bass speakers, said printed circuit board comprising
a receiver for receiving audio signal,
an amplifier receiving said audio signal and transmitting a normal amplified signal to said wide range speakers, said wide range speakers transforming said normal amplifier to normal sound,
a low pass filter receiving said audio signal and dividing low frequency audio signal from said audio signal and then outputting said low frequency audio signal,
a bass amplifier receiving said low frequency audio signal and transmitting an amplified low frequency signal to said bass speakers, said bass speakers transforming said amplified low frequency signal to sound having bass effect.

6. The headset as claimed in claim 5, wherein said receiver further comprises a wireless port for receiving said audio signal via wireless interface and a wired port for receiving said audio signal via wired interface.

7. The headset as claimed in claim 5, further comprising an adjuster unit electronically coupled with said amplifier, said amplifier outputting said normal amplified signal having selective amplified effect according to selective indication signals transmitted from said adjuster unit.

8. The headset as claimed in claim 5, further comprising a processor unit electronically coupled with said amplifier and said wide range speaker respectively, in case said amplifier outputting said normal amplified signal with distortion signal to said processor unit, said processor unit dividing said distortion signal from said normal amplified signal.

9. The headset as claimed in claim 5, further comprising a bass adjuster unit electronically coupled with said bass amplifier, said bass amplifier outputting said amplified low frequency signal having selective amplified effect according to selective indication signals transmitted from said bass adjuster unit.

10. The headset as claimed in claim 5, further comprising a bass processor unit electronically coupled with said bass amplifier and said bass speakers respectively, in case said bass amplifier outputting said amplified low frequency signal with distortion signal to said bass processor unit, said bass processor unit dividing said distortion signal from said amplified low frequency signal.
